(19) United States
(12) Patent Application Publication
(10) Pub. No.: US 2026/0353519 A1
(43) Pub. Date: Nov. 5, 2026

(54) COOKING APPARATUS

(71) Applicant: LG Electronics Inc., Seoul (KR)

(72) Inventors: Eunjung SHIN, Seoul (KR); Hyeunsik NAM, Seoul (KR); Jaepyo HONG, Seoul (KR); Seongjun KIM, Seoul (KR)

(73) Assignee: LG Electronics Inc., Seoul (KR)

(21) Appl. No.: 19/488,573

(22) PCT Filed: Nov. 15, 2024
(86) PCT No.: PCT/KR2024/018123

§ 371 Date: Nov. 26, 2025

(30) Foreign Application Priority Data
Nov. 23, 2023 (KR) 10-2023-0164235

(51) Int. Cl. H05B 3/74; A47J 27/00; F24C 15/34

(52) U.S. Cl. CPC H05B 3/748; A47J 27/004; F24C 15/34

(57) ABSTRACT

A cooking apparatus of one embodiment may comprise: a heating part for heating an object; and a cooktop including an upper plate disposed above the heating part. The heating part includes: a heating coil to which electricity is applied to generate heat; a case for accommodating the heating coil; and an insulation cover which is disposed on the upper side of the case, and which prevents the heat generated by the heating coil from being transferred to the outside, wherein the upper plate can have a plurality of protrusion parts spaced apart from each other on the lower surface thereof facing the insulation cover.

### TECHNICAL FIELD

The present disclosure relates to a cooking appliance, and more particularly, to a cooking appliance having a structure with improved heating efficiency.

### BACKGROUND ART

The contents described in this section merely provides background information on the present disclosure and does not constitute the prior art.

A cooking appliance is one of home appliances for cooking food, and is an appliance installed in a kitchen space to cook food according to a user's intention. Such cooking appliances may be classified in various ways according to a used heat source, a form thereof, and a type of fuel.

Among such cooking appliances, there is a cooktop on which an object to be cooked is placed and which heats the object using a heat source disposed thereunder.

The cooktop may be provided with a heating coil that generates heat upon receiving electricity, and an upper plate which is disposed on top of the heating coil, wherein a container containing food is placed on an upper surface of the upper plate.

It is efficient that an entirety of heat generated from the heating coil passes through the upper plate and is transferred to the container placed on the upper plate. However, not the entirety of the heat generated from the heating coil is transferred to the upper plate, but a portion thereof may be transferred in a direction toward other components of the cooktop.

The cooktop may be provided with a top plate for supporting the upper plate, and the top plate may be disposed adjacent to the heating coil.

In general, the top plate may be made of a metal material that may be easily rolled in order to increase manufacturability. The top plate made of the metal may be a very effective heat dissipation means.

Therefore, the portion of the heat that is not transferred to the upper plate but is discharged to the outside through other components or a gap between parts accommodating the heating coils may be discharged to the outside from the top plate made of the metal material. Thus, a significant amount of heat may not be used to heat the container containing the food and may be discharged into the atmosphere.

Such a structure may degrade the performance of the cooktop and the cooking appliance. Therefore, there is a need for a structure capable of preventing the heat from the heating coil from being discharged through other parts of the cooktop other than the upper plate to the atmosphere so that the heat from the heating coil is not used for heating the container.

### DISCLOSURE

### Technical Purpose

A purpose of the present disclosure is to provide a cooking appliance having a structure capable of suppressing heat transfer from a heating unit of a cooktop to a top plate.

Further, a purpose of the present disclosure is to provide a cooking appliance provided with a thermal insulation member for blocking a gap between an upper plate and a heating unit to suppress heat transfer due to convection through the gap.

Further, a purpose of the present disclosure is to provide a cooking appliance provided with a thermal insulation member which is easily assembled.

The purposes of the present disclosure are not limited to the above-mentioned purposes, and other purposes and advantages of the present disclosure that are not mentioned may be understood based on the following descriptions, and will be more clearly understood based on the embodiments of the present disclosure. In addition, it will be readily appreciated that the purposes and advantages of the present disclosure may be realized by means indicated in the claims and combinations thereof.

### Technical Solution

An embodiment of a cooking appliance may comprise a cooktop comprising a heating unit configured to heat an object and an upper plate disposed on top of the heating unit.

The heating unit may comprise: a heating coil receiving electricity to generate heat; a casing accommodating therein the heating coil; and a thermal insulation cover disposed on top of the casing and suppressing transfer of heat generated from the heating coil to an outside out of the casing, wherein the upper plate has a lower surface facing the thermal insulation cover, wherein a plurality of protrusions spaced apart from each other may be formed on the lower surface of the upper plate.

The cooking appliance may comprise a thermal insulation member disposed between the upper plate and the thermal insulation cover and formed in a shape corresponding to a shape of the thermal insulation cover.

The thermal insulation member may prevent heat generated from the heating coil from being transferred to an outside in a lateral direction of the casing through a gap defined under the lower surface of the upper plate via convection.

The casing may comprise: a bottom surface portion on which the heating coil is accommodated; and a ring-shaped cylindrical side surface portion surrounding an outer edge of the bottom surface portion and protruding upwards therefrom, wherein the thermal insulation cover may be disposed on top of the ring-shaped cylindrical side surface portion and is formed in a ring shape, wherein the thermal insulation member may be formed in a ring shape corresponding to the shape of the thermal insulation cover.

The thermal insulation member may be formed by applying a liquid thermal insulation material so as to fill a gap defined between the protrusions, and curing the applied liquid thermal insulation material.

The thermal insulation member may be made of a solid material covering an upper surface of the thermal insulation cover.

The thermal insulation member may be formed in a shape corresponding to a shape of the thermal insulation cover and prevents heat generated from the heating coil from being transferred to an outside in a lateral direction of the casing through a gap defined under the lower surface of the upper plate via convection.

The thermal insulation member may be made of a flexible material deformable by the protrusion so as to fill a gap defined between the protrusions.

The thermal insulation member may be attached to and detachable from the casing.

The casing may comprise a plurality of first fastening portions protruding outwards from the cylindrical side surface portion and spaced apart from each other in a circumferential direction of the cylindrical side surface portion, wherein the plurality of first fastening portions respectively have holes into which fasteners are respectively fastened.

The thermal insulation member may comprise a plurality of second fastening portions protruding outwards therefrom and spaced apart from each other in a circumferential direction thereof, wherein the plurality of second fastening portions are positioned at positions corresponding to positions of the first fastening portions, and respectively have holes into which the fasteners are respectively fastened.

The first fastening portion and the second fastening portion may be coupled to each other via the fasteners, such that the thermal insulation member may be positioned at an accurate position designed on top of the thermal insulation cover.

According to another embodiment of the cooking appliance, the heating unit may comprise: a heating coil receiving electricity to generate heat; an insulating pad disposed under the heating coil; a casing accommodating therein the heating coil and the thermal insulation pad; and a thermal insulation cover disposed on an upper edge of the casing and extending in a ring shape, wherein the upper plate has a lower surface facing the thermal insulation cover, wherein a plurality of protrusions spaced apart from each other may be formed on the lower surface of the upper plate, wherein the cooking appliance may comprise a thermal insulation member disposed between the upper plate and the insulating cover and formed in a shape corresponding to a shape of the thermal insulation cover.

### Technical Effect

In the cooking appliance according to the present disclosure, the thermal insulation member may be formed in a shape corresponding to a shape of the thermal insulation cover. Accordingly, the heating coil may be sealed by the thermal insulation cover and the thermal insulation member in the lateral direction, and may be sealed by the upper plate in the up-down direction.

The thermal insulation member may fill the gap defined between the protrusions formed on the lower surface of the upper plate. Therefore, the thermal insulation member may effectively prevent the heat generated from the heating coil from being transferred to the outside in the lateral direction of the casing via convection through the gap under the lower surface of the upper plate.

In addition, in the cooking appliance according to the present disclosure, the first fastening portion may be formed on the casing and the second fastening portion may be formed on the thermal insulation member. Due to this structure, the first fastening portion and the second fastening portion may be coupled to each other via the fasteners, such that the thermal insulation member may be positioned at an accurate position designed on top of the thermal insulation cover.

This may effectively prevent an assembly defect that when the cooktop is assembled, the thermal insulation member is removed from the upper surface of the thermal insulation cover, and thus, when the assembly is completed, the thermal insulation member does not fill the gap defined between the upper plate and the thermal insulation cover.

In addition to the above-described effects, specific effects of the present disclosure will be described together while describing specific matters for implementing the present disclosure.

### BRIEF DESCRIPTION OF DRAWINGS

FIG. 1 is a diagram illustrating a cooking appliance according to an embodiment.

FIG. 2 is an exploded view of a cook top according to an embodiment.

FIG. 3 is a perspective view of a heating unit according to an embodiment.

FIG. 4 is a plan view of a heating unit according to an embodiment.

FIG. 5 is an exploded view of a portion of a heating unit according to an embodiment.

FIG. 6 is a cross-sectional view of a cooktop in a state in which there is no thermal insulation member.

FIG. 7 is an enlarged view of a lower surface of an upper plate.

FIG. 8 is an enlarged cross-sectional view illustrating a portion of a cooktop according to an embodiment.

FIG. 9 is a diagram for illustrating a heat transfer tendency in absence of a thermal insulation member.

FIG. 10 is a diagram in which a thermal insulation member is added in FIG. 9.

FIG. 11 is an exploded view of a cook top according to an embodiment.

FIG. 12 is a perspective view of a cooktop according to an embodiment.

FIG. 13 is a diagram of FIG. 12 as viewed in another direction.

FIG. 14 is an exploded view of a cooktop according to another embodiment.

FIG. 15 is a diagram of FIG. 14 as viewed in another direction.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, etc. are used to describe various components, these components are not limited by these terms. These terms are merely used to distinguish one component from another component. Thus, unless specifically stated to the contrary, the first component may be the second component.

As used herein, unless otherwise stated, each component may be provided as one or more components.

As used herein, the singular constitutes “a” and “an” are intended to comprise the plural constitutes as well, unless the context clearly indicates otherwise. Further, the terms “comprise”, “comprising”, “have”, and “having” as used herein should not be construed as necessarily comprising all of various components or steps as described herein, and may be construed as excluding some components or some steps thereof. It will be further understood that the terms “comprise”, “comprising”, “have”, and “having” as used herein specify presence of a component or a step, but do not preclude the presence or addition of another component or step.

Throughout the present disclosure, “A and/or B” means A, B, or A and B, unless otherwise specified, and “C to D” means C inclusive to D inclusive unless otherwise specified.

Throughout the present disclosure, “up-down direction” refers to the up-down direction of a cooking appliance in a state in which the cooking appliance is installed to be used on a daily basis. As used herein, “left-right direction” means a direction orthogonal to the up-down direction, and the front-rear direction means a direction orthogonal to both the up-down direction and the left-right direction. As used herein, “direction between both opposing sides” or “lateral direction” has the same meaning as the left-right direction, and these terms may be used interchangeably with each other herein.

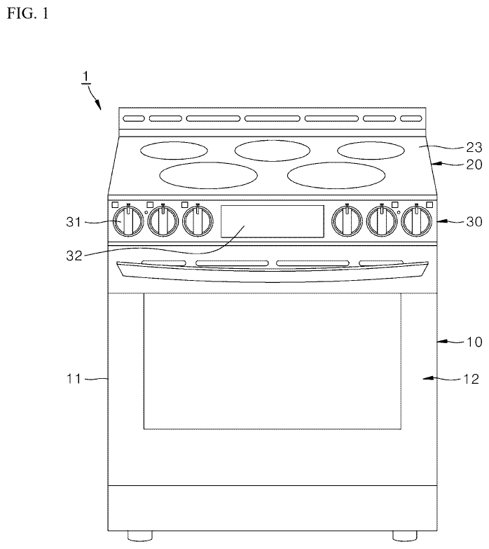

FIG. 1 is a diagram illustrating a cooking appliance according to an embodiment. As illustrated, a cooking appliance 1 according to an embodiment may comprise a cooktop 20. For example, the cooking appliance 1 may be a multi-functional cooking appliance 1 and may comprise a cooktop 20 and an oven 10, and the cooktop 20 may be disposed on top of the oven 10. In another example, the cooking appliance 1 may be configured to have the cooktop 20 alone, and may be built in a furniture cabinet such as a sink or may be placed in a freestanding manner.

Hereinafter, the structure of the multi-functional cooking appliance in which the cooktop 20 is disposed on top of the oven 10 will be described in detail.

The oven 10 may comprise a main body 11 in which a cavity having an open front surface is formed, and a door 12 connected to the main body 11 to open and close the cavity. The cavity have a cooking space defined therein, and a heating source such as a heater or a burner is disposed therein to heat the cooking space to cook food.

In addition, the cooktop 20 may be disposed on top of the oven 10. A container containing food to be cooked may be seated on an upper plate 23 of the cooktop 20, and the container may be heated by a heating unit 22 disposed under the upper plate 23.

The cooking appliance 1 may comprise a manipulator 30. In an example, the manipulator 30 may comprise a plurality of knobs 31, and may manipulate operations of the oven 10 and the cooktop 20.

If necessary, the manipulator 30 may be embodied as a button, a switch, or a touch manipulating device. The manipulator 30 may be disposed on the cooktop 20. In addition, a display 32 for displaying an operating state of the cooking appliance 1 may be provided on one side of the manipulator 30.

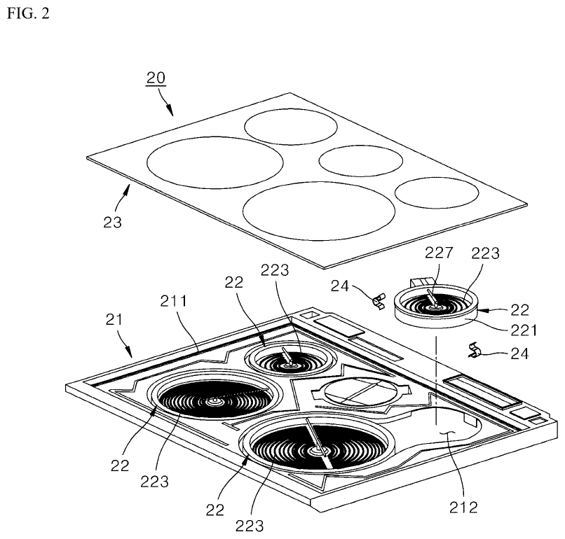

Hereinafter, a structure of the cooktop 20 will be described in more detail with reference to the drawings. FIG. 2 is an exploded view of a cook top according to an embodiment.

As illustrated, the cooktop 20 may comprise a top plate 21, the heating unit 22, and the upper plate 23.

The top plate 21 may accommodate therein a portion of the heating unit 22, and the upper plate 23 may be disposed on an upper surface thereof. The top plate 21 may be formed in a rectangular shape and may constitute an entire frame of the cooktop 20. In addition, the top plate 21 may provide a structure in which the heating unit 22 and the upper plate 23 may be mounted thereto.

For example, the top plate 21 may be made of a metal material, and may constitute a lower portion of the cooktop 20. In the structure in which the cooktop 20 is independently installed, the top plate 21 may define the outer appearance of the remaining portion except for the upper surface of the cooktop 20.

A cutout 212 for mounting the heating unit 22 therein may be formed in the top plate of the cooktop 20. The cutout 212 may be formed to be cut in an area of the top plate where the heating unit 22 is disposed so that the upper plate 23 and a heating coil 223 received in the cutout face each other. The heating unit 22 may be received inside the cutout 212.

A plurality of heating units 22 may be mounted in the cooktop 20. The number of cut-outs 212 formed in the top plate 21 may correspond to the number of the heating units 22. As will be described later, when the two cutouts 212 are integrated into one cutout, the two heating units 22 corresponding to the two cutouts may correspond to the one integrated cutout 212.

The heating unit 22 may heat an object. Here, the object is placed on the upper surface of the upper plate 23 and may be a container containing therein the food to be cooked.

The heating unit 22 may be mounted inside the cutout 212, and may be fixedly mounted in the top plate 21. The heating unit 22 may be configured in various ways according to the type of a heat source. The heating unit may be configured to heat the container placed on the upper surface of the upper plate 23. Hereinafter, for example, the heating unit 22 provided as an electric resistance type heating device will be described.

In one example, the upper plate 23 may be mounted on the upper surface of the top plate of the cooktop 20. The upper plate 23 defines an upper surface of the cooktop 20. The heating unit 22 may be shielded by the upper plate disposed on top of the heating unit while the upper plate is in a mounted state.

In order to mount the upper plate 23, an upper plate receiving space 211 recessed downwards may be formed in the upper surface of the top plate 21. The upper plate receiving space 211 may be recessed so as to have a size corresponding to that of the upper plate 23. In addition, a recessed depth of the upper plate receiving space 211 may correspond to a thickness of the upper plate 23. In addition, a plurality of cutouts 212 may be located in an inner area of the upper plate receiving space 211.

The upper plate 23 may be disposed on top of the heating unit 22. The upper plate 23 is formed in a planar shape to define an upper surface of the cooktop 20, and at the same time, the container to be heated may be seated on the upper plate. Accordingly, the upper plate 23 may be made of a plate-shaped moldable material having heat resistance and high flatness.

For example, the upper plate 23 may be made of a heat-resistant glass, a tempered glass, a ceramic glass, or the like. In addition, the upper plate 23 may be formed to be transparent or opaque. In addition, the upper plate 23 may be formed to have a smooth surface to prevent contamination and discoloration and to maintain excellent cleaning properties.

In addition, a container guide may be formed in the upper plate 23 at a position corresponding to the heating unit 22. The container guide may be positioned vertically above the heating unit 22 and may be formed so as to overlap a circumference of the heating unit 22.

For example, the container guide may be formed in a circular shape corresponding to a shape of the circumference of the heating unit 22. In this case, the container guide may be formed, for example, in a manner of being printed on the upper surface of the upper plate 23.

In one example, the cooktop 20 may comprise a spring 24. The spring 24 may be provided to couple the heating unit 22 to the top plate 21. For example, a plurality of springs 24 may be arranged to be spaced apart from each other in the circumferential direction of a casing 221 of the heating unit 22.

A portion of the spring 24 may be coupled to the heating unit 22, and a portion thereof may be coupled to the top plate 21 to allow the heating unit 22 to be disposed in the cutout 212 of the top plate 22. The spring 24 may be formed in a “C” shape, for example. However, the present disclosure is not limited thereto.

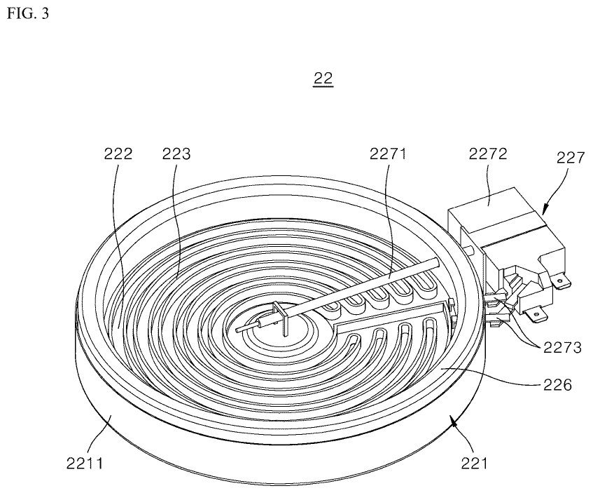

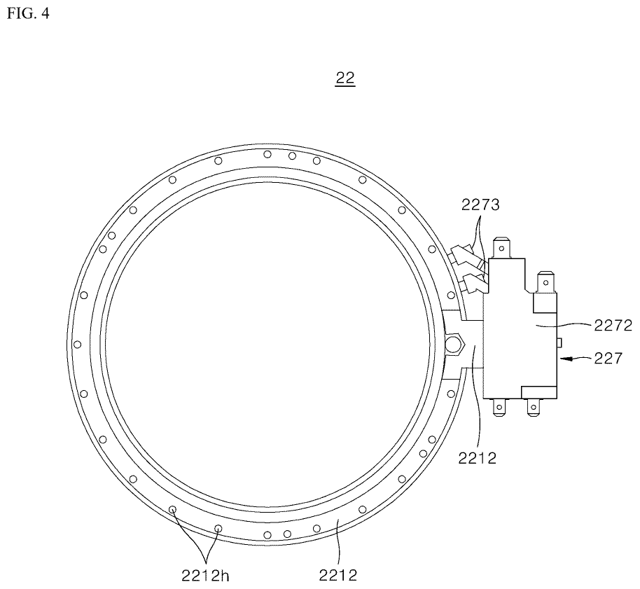

FIG. 3 is a perspective view of a heating unit according to an embodiment. FIG. 4 is a plan view of a heating unit according to an embodiment. The heating unit 22 may comprise the heating coil 223, the casing 221, and a thermistor 227. First, the thermistor 227 will be described. The thermistor 227 may be disposed in the heating unit to measure a temperature of the heating coil 223.

The thermistor 227 may be configured to comprise a thermostat 2271, a housing 2272, a terminal 2273, and a fixing bracket 2274. The thermostat 2271 may measure the temperature of the heating coil 223 and may extend toward a central portion of the heating coil 223.

The thermostat 2271 may sense the temperature of the heating coil 223 to measure the temperature of a position on top of the heating coil 223. The thermostat 2271 is disposed to be slightly spaced apart from the heating coil 223 without being in contact with the heating coil 223, such that the temperature of the area on top of the heating coil 223 may be measured by the thermostat 2271.

The housing 2272 may be coupled to the thermostat 2271, and a device for electrically connecting the heating coil 223 and an external power source to each other may be accommodated therein. In addition, a switch device capable of controlling on/off of the heating coil 223 by connecting and discontenting the heating coil 223 to and from the power source may be provided inside the housing 2272.

When the temperature of the heating coil 223 measured by the thermostat 2271 exceeds a set temperature, this indicates that the heating coil 223 is overheated. In this case, the switch device may operate to turn off the heating coil 223.

The terminal 2273 may be electrically connected to the heating coil 223 and protrude out of the casing 221. The external power source is electrically connected to the terminal 2273. The heating coil 223 may be heated when the electricity from the external power source is applied thereto.

The fixing bracket 2274 may protrude from the housing 2272, and an end thereof may be coupled to the casing 221. Accordingly, the housing 2272 may be fixedly coupled to the casing 221 by the fixing bracket 2274 so that the thermostat 2271 may maintain a designed position.

The heating coil 223 may generate heat upon receiving the electricity. In an embodiment, the heating coil 223 may be provided as a coil heated in an electrical resistance manner. In this regard, the heat generated from the heating coil 223 may pass through the upper plate 23 to heat the container containing therein the food via radiation or conduction. The casing 221 may accommodate therein the heating coil 223 and a thermal insulation pad 222 to be described later.

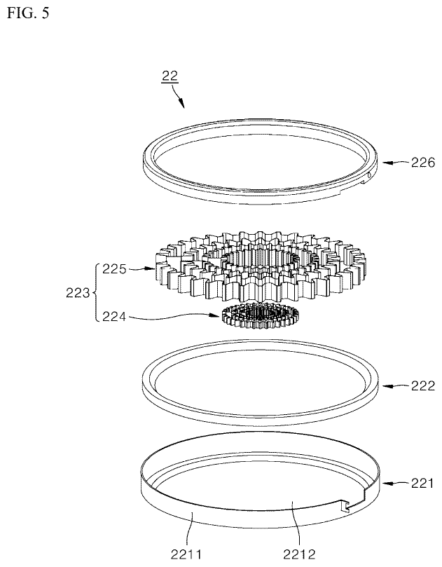

FIG. 5 is an exploded view of a portion of a heating unit according to an embodiment. In FIG. 5, the illustration of the thermistor 227 is omitted. As illustrated in FIG. 5, the casing 221 may comprise a cylindrical side surface portion 2211 and a bottom surface portion 2212.

The bottom surface portion 2212 may constitute a lower surface of the casing 221, may be generally formed in a circular shape, and may accommodate thereon the heating coil 223. The cylindrical side surface portion 2211 may surround an outer side of the bottom surface portion 2212, and protrude upwards, and be formed in a ring shape.

Due to this structure, the bottom surface portion 2212 and the cylindrical side surface portion 2211 may define a space capable of accommodating therein the heating coil 223 and the thermal insulation pad 222.

The cylindrical side surface portion 2211 may comprise a first surface bent from an edge of the bottom surface and a second surface bent from the first surface extending in a lateral direction. In this regard, a plurality of fastening holes 2212h for fastening the ring-shaped thermal insulation member to the second surface may be formed in the bottom of the second surface and may be arranged along a circumferential direction of the second surface.

Referring to FIG. 5, the heating unit 22 may comprise the thermal insulation pad 222 and a thermal insulation cover 226.

The thermal insulation pad 222 may be disposed under the heating coil 223, and the thermal insulation pad 222 may be disposed in a lower portion of the inner space of the casing 221 of the heating unit 22, and may be made of a thermal insulation material. Therefore, when the heating coil 223 generates the heat, the thermal insulation pad 222 may prevent the heat from being transferred downwards. In addition, the heating coil 223 may be disposed on top of the thermal insulation pad 222.

The thermal insulation cover 226 may be disposed on top of the casing 221 and may prevent the heat generated from the heating coil 223 from being transferred to the outside. The thermal insulation cover 226 may be formed in a ring shape and extend along an upper edge of the heating unit 22. The thermal insulation cover 226 may be made of a thermal insulation material, and an upper end of the thermal insulation cover 226 may be provided to face a lower surface of the upper plate.

In this regard, the upper end of the thermal insulation cover 226 and the lower surface of the upper plate may be in contact with each other or may be slightly spaced apart from each other in the up-down direction depending on the design.

The thermal insulation cover 226 may prevent the heat generated from the heating coil 223 from being transferred in the lateral direction of the cooktop and may allow the heat to be transferred in the upward direction of the cooktop, thereby improving the thermal efficiency of the cooktop.

In one example, as illustrated in FIG. 5, the heating coil 223 may be divided into, for example, an inner coil 224 and an outer coil 225. Accordingly, the amount of heat for heating the container 2 may be adjusted according to a combination of on/off operations of the inner coil 224 and the outer coil 225.

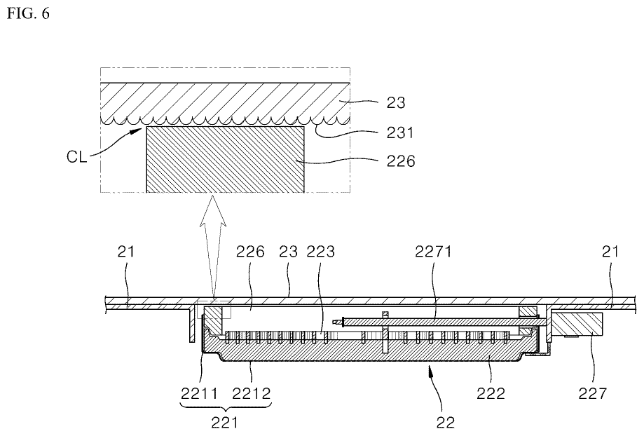

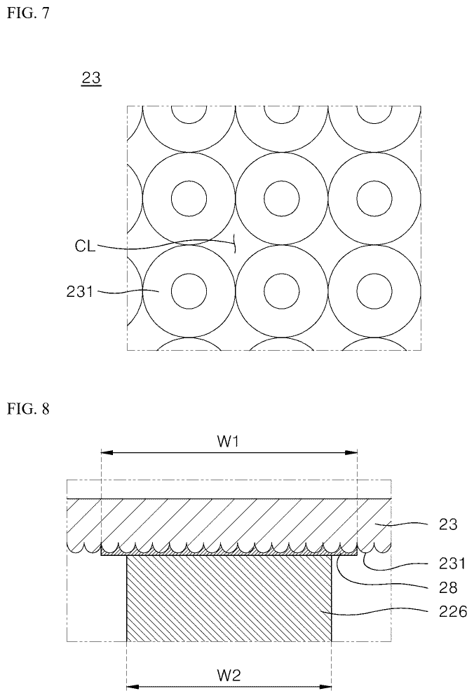

In an embodiment, it is efficient that the entirety of the heat generated from the heating coil 223 passes through the upper plate 23 and is transferred to the container placed on the upper plate 23. However, the heat generated from the heating coil 223 may be transferred in the lateral direction of the cooktop 20. This will be described first with reference to FIGS. 6 and 7.

FIG. 6 is a cross-sectional view of the cooktop 20 without the thermal insulation member 28. FIG. 7 is an enlarged view of a lower surface of the upper plate 23. The upper plate 23 may be generally made of a glass material having good heat resistance. The upper plate 23 made of such a glass material may be damaged due to cracks occurring during the manufacturing process.

A protrusion 231 may be formed on the upper plate 23 to suppress the occurrence of cracks. The upper plate 23 may have a plurality of protrusions 231 formed on a lower surface thereof facing the thermal insulation cover 226 and arranged so as to be spaced apart from each other.

In addition, in terms of the manufacturing process, it may be easier to form the protrusion 231 on the lower surface of the upper plate 23 than to process the lower surface of the upper plate 23 into a complete flat surface, and thus the former may be more effective to the reduce cost than the latter may be.

In one example, a circular print for guiding the position of the heating coil 223 or a print of a character for guiding other uses should be formed on the upper surface of the upper plate 23. Further, the upper surface of the upper plate is a surface visible to the user. For this reason, the protrusion 231 may not be formed on the upper surface thereof for aesthetics.

Referring to FIG. 7, the plurality of protrusions 231 may be arranged to be spaced apart from each other. The protrusions 231 may be arranged in the longitudinal and transverse directions of the upper plate 23. For example, the protrusion 231 may be formed in a conical shape having a distal end being generally blunt and non-sharp.

Ends of the protrusions 231 contacting the lower surface of the upper plate 23 may be disposed to be in contact with each other. Due to the conical shape thereof, the distal ends thereof may be spaced apart from each other rather than being in contact with each other. Due to this structure, a gap CL through which air may flow may be defined between adjacent ones of the plurality of protrusions 231.

Referring to FIG. 6, in the cooktop 20, the upper surface of the thermal insulation cover 226 of the heating unit 22 and the lower surface of the upper plate 23 may be in contact with each other or may be slightly spaced apart from each other in the up-down direction. In this case, the gap CL defined between the protrusions 231 may be defined between the upper plate 23 and the thermal insulation cover 226.

A cross-sectional area of the protrusion 231 of the conical shape gradually decreases as the protrusion 231 extends to the distal end. Thus, the cross-sectional area of the gap CL defined between the upper plate 23 and the thermal insulation cover 226 may be gradually increased in inverse proportion to the cross-sectional area of the protrusion 231 as the protrusion 231 extends to the distal end, thereby defining a sufficient space in which the air flows.

When the air flows through the gap CL, heat transfer may be generated from the heating unit 22 to the outside out of the cooktop 20 via the convection. A lower portion of the top plate 21 is disposed outside the heating unit 22, such that the heat flowing from the heating unit 22 to the outside out of the heating unit in the lateral direction of the cooktop 20 via the convection may be transmitted to the top plate 21.

That is, the lateral heat transfer of the cooktop 20 may be transferred to the top plate 21 surrounding the heating unit 22. The top plate 21 may be made of a metal material that may be easily rolled in order to increase manufacturability.

The top plate 21 made of the metal material may be a very effective heat dissipation means. Therefore, the heat discharged in the lateral direction of the cooktop 20 is discharged from the top plate 21 made of the metal material out of the cooktop, and thus a considerable amount of heat is not used to heat the container and may be discharged to the atmosphere.

This structure may degrade the performance of the cooktop 20 and the cooking appliance 1. Therefore, a structure capable of preventing the heat from the heating unit 22 from being transferred through the components of the heating unit 22 other than the upper plate 23 to the atmosphere so as not to be used to heat the container of the heating coil 223 is required.

The structure of the cooking appliance 1 according to an embodiment for this purpose will be described in detail with reference to the drawings.

FIG. 8 is an enlarged cross-sectional view illustrating a portion of the cooktop 20 according to an embodiment. The cooking appliance 1 may comprise a thermal insulation member 28 disposed between the upper plate 23 and the thermal insulation cover 226 and formed in a shape corresponding to that of the thermal insulation cover 226.

The thermal insulation member 28 may be disposed between the upper plate 23 and the thermal insulation cover 226 to fill the gap CL defined between the protrusions 231 formed on the lower surface of the upper plate 23. The gap CL may be formed between the upper plate 23 and the thermal insulation cover 226 due to the protrusions 231, and the thermal insulation member 28 may fill the gap CL to prevent the air from flowing through the gap CL.

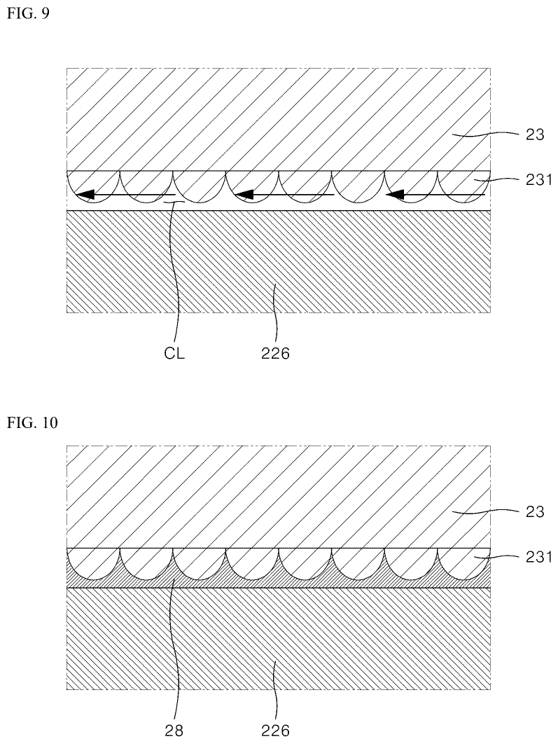

FIG. 9 is a diagram for illustrating a heat transfer tendency in absence of the thermal insulation member 28. In FIG. 9, an arrow indicates a heat transfer direction.

In the absence of the thermal insulation member 28, the gap CL may be formed between the upper plate 23 and the thermal insulation cover 226 due to the protrusions 231, and the gap CL may act as a space having a sufficient size to allow air to flow therethrough.

Accordingly, the heat generated from the heating coil 223 may flow in the lateral direction of the thermal insulation cover 226 and may be transferred to the lower portion of the top plate 21 disposed outside the thermal insulation cover 226. In this regard, the thermal insulation cover 226 has good thermal insulation performance, such that the lateral heat transfer through the thermal insulation cover 226 may be suppressed, but the heat transfer may occur through the gap CL on top of the thermal insulation cover 226.

The convective heat transfer through the gap CL may lower the heating efficiency of the cooktop 20.

FIG. 10 is a diagram in which the thermal insulation member 28 is added in FIG. 9. The thermal insulation member 28 may fill the gap CL defined between the upper plate 23 and the thermal insulation cover 226. In particular, the thermal insulation member 28 may fill an entirety of the gap CL defined between adjacent ones of the plurality of protrusions 231 formed on the lower surface of the upper plate 23.

Due to this structure, when the thermal insulation member 28 is added, the gap CL defined between the upper plate 23 and the thermal insulation cover 226 is eliminated, and accordingly, air convection through the gap CL is eliminated, and thus heat transfer due to convection may be blocked.

In an embodiment, the thermal insulation cover 226 may be disposed on an edge of the casing 221 so as to surround the heating coil 223. Since the thermal insulation cover 226 is intended for preventing the heat generated from the heating coil 223 from being transferred in the lateral direction, the thermal insulation cover 226 extends to surround the heating coil 223.

The thermal insulation member 28 may be provided in a shape corresponding to a shape of the thermal insulation cover 226. Accordingly, the heating coil 223 may be sealed by the thermal insulation cover 226 and the thermal insulation member 28 in the lateral direction, and may be sealed by the upper plate 23 in the up-down direction.

As described above, the thermal insulation member 28 may fill the gap CL due to the protrusions 231 formed on the lower surface of the upper plate 23. Therefore, the thermal insulation member 28 may effectively prevent the heat generated from the heating coil 223 from being transferred to the outside in the lateral direction of the casing 221 through the gap CL formed under the lower surface of the upper plate 23 via the convection.

The gaps CL are formed defined by the plurality of protrusions 231 arranged in the longitudinal direction and the transverse direction. For this reason, the shape of each of the gaps CL is three-dimensional and complex. There is a need for a scheme for entirely filling the gap CL of such a complex shape.

One scheme of filling the gap CL having a complex shape is to provide and cure the liquid thermal insulation member 28. That is, the thermal insulation member 28 may be applied in a liquid phase to fill the gap CL between the protrusions 231 and may be cured.

The liquid thermal insulation member 28 may be applied to at least one of the upper surface of the thermal insulation cover 226 or the lower surface of the upper plate 23, and then the upper plate 23 may be placed on the thermal insulation cover 226 and then the liquid thermal insulation member 28 may be cured.

The liquid thermal insulation member 28 may be applied to the upper surface of the thermal insulation cover 226 and/or the lower surface of the upper plate 23 in a sprayed manner, in an applied manner using a brush, or the like. When the liquid thermal insulation member 28 has been applied to the upper surface of the thermal insulation cover 226, the liquid thermal insulation member 28 may be easily applied to a correct position.

Alternatively, the liquid thermal insulation member 28 may be applied to the lower surface of the upper plate 23. In this case, it may be cumbersome for the liquid thermal insulation member 28 to be applied to the upper plate 23 in a corresponding manner to the exact position and shape of the upper surface of the thermal insulation cover 226. However, in this case, there is an advantage in that it is possible to easily fill the gap CL formed under the lower surface of the upper plate 23.

In one example, the thermal insulation member 28 may be made of a thermosetting or ultraviolet curable material. In order to quickly assemble the cooktop 20, after the upper plate 23 has been placed on the thermal insulation cover 226, it is necessary to rapidly cure the liquid thermal insulation member 28.

Therefore, it may be appropriate to apply the liquid thermal insulation member 28 made of the thermosetting or ultraviolet curable material and to quickly cure the liquid thermal insulation member 28 using heat or ultraviolet rays.

When the liquid thermal insulation member 28 is used, the amount of application thereof may be adjusted. Thus, the thermal insulation member 28 may be provided on the cooktop 20 so as to be thin enough to fill the gap CL. Due to this structure, the entire cooktop 20 is prevented from being unnecessarily thickened in the up-down direction, and the entire cooktop 20 may be manufactured to be slim.

Another scheme of filling the gap CL of a complex shape is to use the thermal insulation member 28 made of a flexible material.

Accordingly, the thermal insulation member 28 may be made of a solid material covering the upper surface of the thermal insulation cover 226. In addition, the thermal insulation member 28 may be made of a flexible material that is deformable upon contact with the protrusion 231 to fill the gap CL formed between the protrusions 231.

When the upper plate 23 is mounted into the upper plate receiving space 211 in a state in which the thermal insulation member 28 has been placed on the upper surface of the thermal insulation cover 226, the thermal insulation member 28 made of the flexible material may be pressed by the upper plate 23 and thus be deformed, such that the deformed thermal insulation member 28 may entirely fill the gap CL defined between the protrusions 231.

When the thermal insulation member 28 is made of the flexible solid material, a thickness of the thermal insulation member 28 may be slightly greater than that when the thermal insulation member 28 is applied in the liquid phase and is cured. However, when the insulation member 28 is made of the flexible solid material, the thermal insulation member 28 may be removed from the thermal insulation cover 226 or the upper plate 23 and thus be attached thereto or detached therefrom, such that the cooktop 20 may have a good assemblability and the thermal insulation member 28 may be replaced.

As illustrated in FIG. 8, a width W1 of the thermal insulation member 28 may be sized to be larger than a width W2 of the thermal insulation cover 226. When the thermal insulation member 28 is applied in the liquid state, such a structure may be implemented by applying the liquid thermal insulation member 28 having the width WI to the lower surface of the upper plate 23.

In another example, when the thermal insulation member 28 is made of the solid flexible material, the width W1 of the thermal insulation member 28 may be sized to be larger than the width W2 of the thermal insulation cover 226.

Due to this structure, the width W1 of the thermal insulation member 28 may be sufficiently large to effectively suppress the occurrence of the defect in which a portion of the gap CL defined between the upper plate 23 and the thermal insulation cover 226 is not filled with the thermal insulation member in the process of applying or assembling the thermal insulation member 28.

The thermal insulation member 28 entirely fills and seals the gap CL defined between the upper plate 23 and the thermal insulation cover 226, so that the heat transfer due to convection of the air through the gap CL may be more reliably blocked.

The thermal insulation member 28 may be made of a material having high thermal insulation properties and good heat resistance. As described above, the thermal insulation member 28 may be made of a material that may be prepared in a liquid phase, be applied, and be cured to form the solid, or be made of a flexible material in a solid phase.

In this regard, the thermal insulation member 28 may be made of a material comprising at least one of Al₂O₃, SiO₂, and TiO₂ as a material having high thermal insulation properties and good heat resistance.

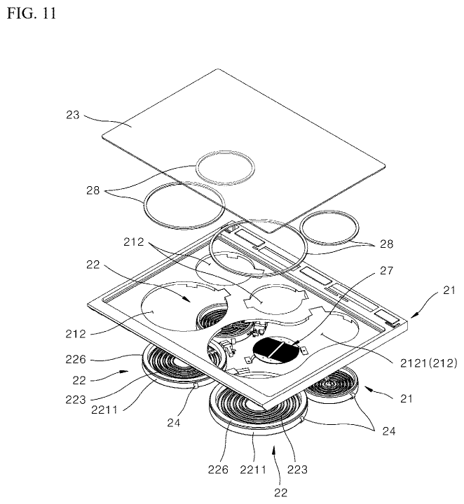

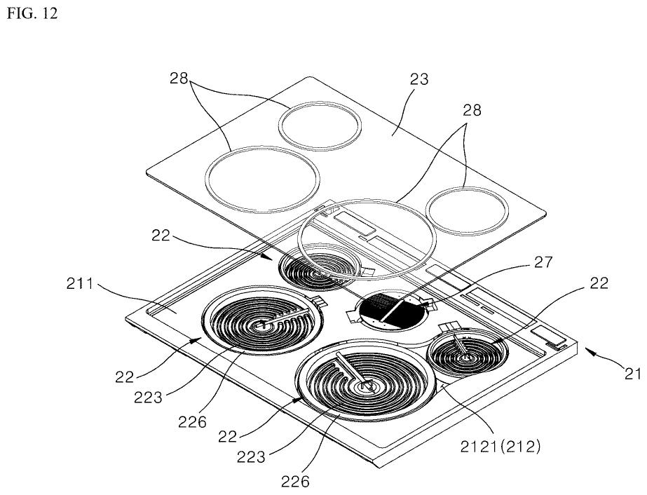

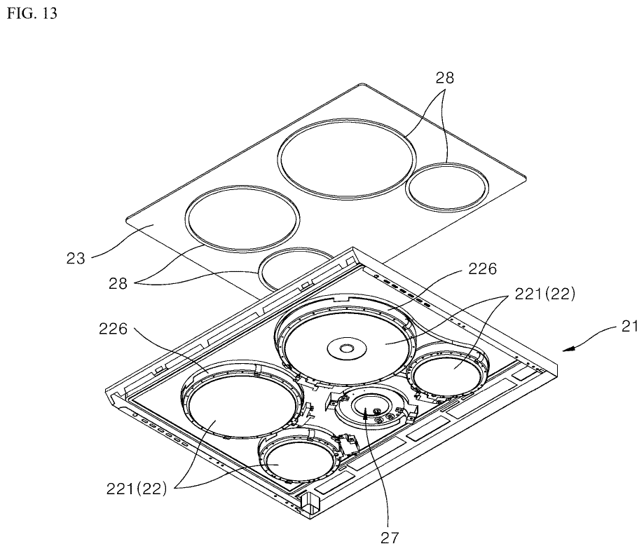

FIG. 11 is an exploded view of the cooktop 20 according to an embodiment. FIG. 12 is a perspective view of the cooktop 20 according to an embodiment. FIG. 13 is a diagram of FIG. 12 as viewed in another direction.

The thermal insulation cover 226 may be disposed on top of the cylindrical side surface portion 2211 and may be provided in a ring shape, and the thermal insulation member 28 may be provided in a ring shape corresponding to a shape of the thermal insulation cover 226.

The thermal insulation member 28 of the embodiment illustrated in FIG. 11 may be formed by preparing a thermal insulation material in a liquid state, then applying the thermal insulation material onto at least one of the lower surface of the upper plate 23 or the upper surface of the thermal insulation cover 226, and then placing the upper plate 23 on top of the thermal insulation cover 226 such that the cooktop 20 is assembled, and then curing the applied thermal insulation material.

The thermal insulation member 28 may be provided as a plurality of thermal insulation members, the number thereof corresponding to the number of the plurality of heating units 22, wherein each of thermal insulation members may be disposed on each heating unit 22. Referring to FIG. 11, the cooktop 20 may comprise a warming unit 27. The warming unit 27 refers to a device for heating food contained in a container placed on top thereof or maintaining the warmth of the food. Accordingly, the warming unit 27 may dissipate heat of a temperature lower than that of the heating unit 22.

However, the amount of heat emitted from the warming unit 27 is much smaller than the amount of heat emitted from the heating unit 22. Thus, the amount of lateral heat transfer between the warming unit 27 and the top plate 21 may be significantly smaller than the amount of lateral heat transfer between the heating unit 22 and the top plate. In addition, the lateral heat transfer amount is small and thus cannot be regarded as a significant thermal loss. Thus, the thermal insulation cover 226 may not be disposed on the warming unit 27.

Therefore, the thermal insulation member 28 surrounding the warming unit 27 may not be provided in consideration of the relatively small thermal insulation effect obtained when the thermal insulation member 28 is disposed on the warming unit 27, and in consideration of the fact that the thermal insulation cover 226 is not disposed on the warming unit 27, and in terms of the effort and cost of forming the thermal insulation member 28.

In the cooktop 20 of the embodiment, the plurality of heating units 22 may be provided, and the cutouts 212 may be integrated with each other into at least one integrated cutout 2121 for integrally accommodating adjacent heating units 22 with each other.

The integrated cutout 2121 may be provided in a peanut or dumbbell shape in which the circular cutouts 212 spaced apart from each other are integrated with each other. The integrated cutout 2121 may be formed by cutting a partial piece that constitute an upper portion of the top plate 21 disposed between the cutouts 212 spaced apart from each other.

If there is a partial piece of the top plate 21 that spaces the adjacent cutouts 212 apart from each other, the heat transfer may be generated from the heating unit 22 to the piece and then the heat may be spread to the entirety of the top plate 21.

In this structure, the amount of heat directly transferred from the heating unit 22 to the container through the upper plate 23 may be reduced, and the amount of heat discharged to the atmosphere through the top plate 21 may be increased.

That is, the integrated cutout 2121 may be formed to remove the partial piece of the top plate 21, such that the heat dissipation area of the upper portion of the top plate 21 may be reduced, thereby improving the heating efficiency of the cooktop 20.

The plurality of heating units 22 and the plurality of thermal insulation covers 226 may be disposed in one integrated cutout 2121. Accordingly, the number of thermal insulation members 28 corresponding to each of the number of the heating units 22 and the number of the thermal insulation covers 226 may be disposed in one integrated cutout 2121.

In the embodiment illustrated in FIG. 11, two heating units 22 and two insulating covers 226 are disposed in one integrated cutout 2121. Thus, two insulation members 28 may also be disposed in one integrated cutout 2121.

The solid thermal insulation member 28 may be attachable to and detachable from the cooktop 20. That is, the thermal insulation member 28 may be removed from other components of the cooktop 20, such that the cooktop 20 may have better assemblability, and the thermal insulation member 28 may be easily replaced, compared to the case in which the thermal insulation member 28 is formed by applying the liquid material and curing the same.

In this regard, when the thermal insulation member 28 is assembled, the thermal insulation member 28 may be accurately disposed at a position corresponding to a position of the thermal insulation cover 226, thereby improving the ease of the assembly. Such a structure will be described in detail below with reference to the drawings.

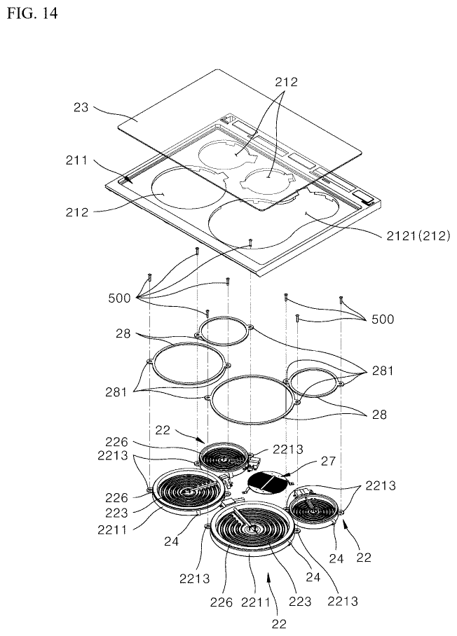

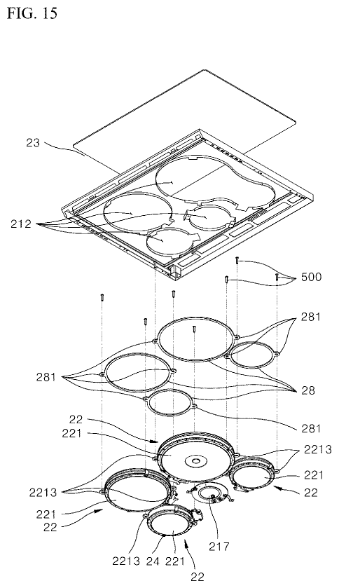

FIG. 14 is an exploded view of the cooktop 20 according to another embodiment. FIG. 15 is a diagram of FIG. 14 as viewed in another direction. The casing 221 and the thermal insulation member 28 may be provided with fastening portions so that the thermal insulation member 28 is detachably attached to the casing 221.

The casing 221 may comprise a plurality of first fastening portions 2213 protruding outwardly from the cylindrical side surface portion 2211 and spaced apart from each other in the circumferential direction of the cylindrical side surface portion 2211. The plurality of first fastening portions 2213 have holes to which fasteners 500 are respectively fastened.

In other words, the plurality of first fastening portions 2213 may protrude outwards from the casing 221, may be arranged to be spaced apart from each other in the circumferential direction of the casing 221, and may have the holes to which the fasteners 500 are respectively fastened.

The thermal insulation member 28 may comprise a plurality of second fastening portions 281 protruding outwards and spaced apart from each other in the circumferential direction, provided at positions corresponding to those of the first fastening portions 2213, and having holes to which the fasteners 500 are respectively fastened.

The cylindrical side surface portion 2211 may be formed in the ring shape, and the ring-shaped thermal insulation cover 226 may be disposed on top of the cylindrical side surface portion 2211. In addition, the thermal insulation member 28 may be formed in the ring shape to correspond to the shape of the thermal insulation cover 226.

Accordingly, the plurality of first fastening portions 2213 may be arranged to be spaced apart from each other in the circumferential direction of the ring-shaped cylindrical side surface portion 2211. The plurality of second fastening portions 281 may also be arranged to be spaced apart from each other in the circumferential direction of the ring-shaped thermal insulation cover 226.

Due to this structure, the first fastening portion 2213 and the second fastening portion 281 are coupled to each other vis the fasteners 500 such as the screws or the like, so that the thermal insulation member 28 may be positioned at a designed exact position on top of the thermal insulation cover 226.

In an embodiment, the first fastening portion 2213 may be formed on the casing 221, and the second fastening portion 281 may be formed on the thermal insulation member 28. Due to this structure, the first fastening portion 2213 and the second fastening portion 281 are coupled to each other by the fastener 500, and the thermal insulation member 28 may be positioned at an accurate designed position on top of the thermal insulation cover 226.

Accordingly, this may effectively prevent an assembly defect that when the cooktop 20 is assembled, the thermal insulation member 28 is removed from the upper surface of the thermal insulation cover 226, and thus, when the assembly is completed, the thermal insulation member 28 does not fill the gap CL defined between the upper plate 23 and the thermal insulation cover 226.

Although the present disclosure has been described above with reference to the drawings, the present disclosure is not limited to the embodiments disclosed herein and the drawings, and it is obvious that various modifications may be made thereto by those skilled in the art within the scope of the technical idea of the present disclosure. In addition, even when the effects according to the configurations of the present disclosure were not explicitly described while describing the embodiments of the present disclosure, it is obvious that the effects predictable from the configurations should also be acknowledged.

1. A cooking appliance comprising a cooktop, wherein the cooktop comprises:
a heating unit for heating an object; and
an upper plate disposed on top of the heating unit,
wherein the heating unit comprises:
a heating coil receiving electricity to generate heat;
a casing accommodating therein the heating coil; and
a thermal insulation cover disposed on top of the casing and suppressing transfer of heat generated from the heating coil to an outside out of the casing,
wherein the upper plate has a lower surface facing the thermal insulation cover, wherein a plurality of protrusions spaced apart from each other are formed on the lower surface of the upper plate,
wherein the cooking appliance further comprises a thermal insulation member disposed between the upper plate and the thermal insulation cover.

2. The cooking appliance of claim 1, wherein the casing comprises:
a bottom surface portion on which the heating coil is accommodated; and
a ring-shaped cylindrical side surface portion surrounding an outer edge of the bottom surface portion and protruding upwards therefrom,
wherein the thermal insulation cover is disposed on top of the ring-shaped cylindrical side surface portion and is formed in a ring shape,
wherein the thermal insulation member is formed in a ring shape corresponding to the shape of the thermal insulation cover.

3. The cooking appliance of claim 1, wherein the thermal insulation member is formed by applying a liquid thermal insulation material so as to fill a gap defined between the protrusions, and curing the applied liquid thermal insulation material.

4. The cooking appliance of claim 3, wherein the thermal insulation member is made of a thermosetting or ultraviolet curable material.

5. The cooking appliance of claim 3, wherein the thermal insulation member is formed by applying the liquid thermal insulation material on at least one of an upper surface of the thermal insulation cover or the lower surface of the upper plate, and then placing the upper plate on the thermal insulation cover, and then curing the applied liquid thermal insulation material.

6. The cooking appliance of claim 1, wherein the thermal insulation cover is disposed on an outer edge of the casing so as to surround the heating coil,
wherein the thermal insulation member is formed in a shape corresponding to a shape of the thermal insulation cover and prevents heat generated from the heating coil from being transferred to an outside in a lateral direction of the casing through a gap defined under the lower surface of the upper plate via convection.

7. The cooking appliance of claim 2, wherein the thermal insulation member is made of a solid material covering an upper surface of the thermal insulation cover.

8. The cooking appliance of claim 7, wherein the thermal insulation member is made of a flexible material deformable by the protrusion so as to fill a gap defined between the protrusions.

9. The cooking appliance of claim 7, wherein the thermal insulation member is attached to and detachable from the casing.

10. The cooking appliance of claim 9, wherein the casing comprises a plurality of first fastening portions protruding outwards from the cylindrical side surface portion and spaced apart from each other in a circumferential direction of the cylindrical side surface portion, wherein the plurality of first fastening portions respectively have holes into which fasteners are respectively fastened,
wherein the thermal insulation member comprises a plurality of second fastening portions protruding outwards therefrom and spaced apart from each other in a circumferential direction thereof, wherein the plurality of second fastening portions are positioned at positions corresponding to positions of the first fastening portions, and respectively have holes into which the fasteners are respectively fastened.

11. The cooking appliance of claim 2, wherein a width of the thermal insulation member is sized to be larger than a width of the thermal insulation cover.

12. The cooking appliance of claim 1, wherein the thermal insulation member is made of a material comprising at least one of Al₂O₃, SiO₂, or TiO₂.

13. A cooking appliance comprising a cooktop, wherein the cooktop comprises:
a heating unit for heating an object; and
an upper plate disposed on top of the heating unit,
wherein the heating unit comprises:
a heating coil receiving electricity to generate heat;
an insulating pad disposed under the heating coil;
a casing accommodating therein the heating coil and the thermal insulation pad; and
a thermal insulation cover disposed on an upper edge of the casing and extending in a ring shape,
wherein the upper plate has a lower surface facing the thermal insulation cover, wherein a plurality of protrusions spaced apart from each other are formed on the lower surface of the upper plate,
wherein the cooking appliance comprises a thermal insulation member disposed between the upper plate and the thermal insulation cover and formed in a shape corresponding to a shape of the thermal insulation cover.

14. The cooking appliance of claim 13, wherein the thermal insulation member is formed by applying a liquid thermal insulation material on at least one of an upper surface of the thermal insulation cover or the lower surface of the upper plate, and then placing the upper plate on the thermal insulation cover, and then curing the applied liquid thermal insulation material.

15. The cooking appliance of claim 13, wherein the casing comprises a plurality of first fastening portions protruding outwards from the casing and spaced apart from each other in a circumferential direction of the casing, wherein the plurality of first fastening portions respectively have holes into which fasteners are respectively fastened,
wherein the thermal insulation member comprises a plurality of second fastening portions protruding outwards therefrom and spaced apart from each other in a circumferential direction thereof, wherein the plurality of second fastening portions are positioned at positions corresponding to positions of the first fastening portions.
